(19) United States
(12) Patent Application Publication
(10) Pub. No.: US 2004/0189252 A1
(43) Pub. Date: Sep. 30, 2004

(54) Device for controlling the state of charge at constant voltage of a battery of secondary electrochemical cells

(75) Inventors: Thierry Berlureau, Bordeaux (FR); Pascal Lavaur, Bordeaux (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/736,540

(22) Filed: Dec. 17, 2003

(30) Foreign Application Priority Data
Dec. 20, 2002 (FR) 02 16 342

(51) Int. Cl. H02J 7/00

(52) U.S. Cl. 320/128

(57) ABSTRACT

A device (1) for controlling the charging of a battery (2) of secondary electrochemical cells (7), the device being interfaced between a battery charger (3), the battery, and a piece of electrical equipment (4), and comprising firstly measurement means (6) delivering measurements of a first physical magnitude representative of at least one voltage (V) across the terminals of at least a portion of the battery (2), and of a second physical magnitude representative of at least one temperature (T) of at least a portion of the battery (2), and secondly control means (8) capable of determining, as a function of the measured first and second magnitudes, an electrical reference value enabling the battery (2) to be maintained in a selected state of charge and at a mean temperature substantially below a selected threshold by means of a continuous low current at constant voltage.

The invention relates to the field of electric cells, and more particularly to the field of secondary electrochemical cells, more commonly known as rechargeable batteries (or battery units).

Rechargeable batteries are generally constituted by a plurality of secondary electrochemical cells (also known as storage cells, rechargeable cells, or indeed accumulators), connected in series and/or in parallel. Such batteries are commonly intended for powering electrical equipment, also referred to as“applications”.

Amongst such batteries, some are known as being “maintenance-free” and are required to present very long lifetime, typically a few years to a few tens of years. This applies in particular to alkaline batteries of the nickel/metal-hydride (Ni/MH) type and of the nickel/cadmium (Ni/Cd) type, or to batteries of the lithium/ion (Li/Ion) type, or of the lead-acid (Pb/PbO₂) type.

In order to achieve such performance, those batteries are generally coupled to a battery charger suitable for feeding them with electricity when their state of charge so requires. However, the active materials of which such batteries are made tend to deteriorate more quickly when their mean temperature is high and when they are subjected to too many poor detections of end-of-charging (or abusive overcharges). As a result, after a length of time that varies as a function of conditions of use, the charger can no longer suffice to maintain batteries at a level of performance that is sufficient for the applications with which they are coupled. Furthermore, constant-voltage charging of couples such as Ni—Cd or Ni—MH can lead to thermal runaway.

In an attempt to remedy those drawbacks, proposals have been made to place a control device at the interface between the charger, the application, and the battery, the control device serving to monitor the state of charge of the battery, and in particular to attempt to prevent the state of charge firstly from exceeding an over-charge threshold, and secondly from dropping below a discharge threshold, and to do so without measuring current (since that is expensive and complex to achieve, given that it would require both small currents and very strong currents to be measured accurately).

Among the numerous control devices already proposed, two are more particularly of interest. They are described in French patent document FR 2 817 403 and Japanese patent document JP-11 225 445. They enable the battery to be subjected to intermittent charging by chopping using an electronic switch in the event of end-of-charging being detected. Although that solution is indeed of interest, it requires the current flowing through the battery to be measured continuously, and that tends to reduce its reliability and to significantly increase its cost. In addition, that solution is suitable only for so-called “constant current” chargers and not for so-called “constant voltage” chargers.

An object of the invention is thus to remedy the above-mentioned drawbacks in full or in part.

To this end, the invention provides a device for controlling the charging of a battery of secondary electrochemical cells (e.g. nickel/metal-hydride (Ni/MH), nickel/cadmium (Ni/Cd), or lithium/ion (Li/Ion), or lead-acid (Pb/PbO₂) storage cells), the device being interfaced between a battery charger, the battery, and electrical equipment, and comprising: firstly measurement means for delivering measurements of a first physical magnitude representative of the voltage across the terminals of at least a portion of the battery, and of a second physical magnitude representative of the temperature of at least a portion of the battery; and secondly control means capable, as a function of the measurements of the first and second magnitudes, of determining an electrical reference value (a current value or a voltage value depending on the type of charger) enabling the battery to be maintained in a selected state of charge and at a mean temperature that is substantially lower than a selected threshold by providing it with a continuous low current at constant voltage and without measuring said current.

In other words, the invention guarantees a maximum state of charge in a minimum length of time and this state of charge is maintained by means of a determined continuous low current in such a manner that the temperature of the secondary electrochemical cells is as low as possible in order to degrade the “instantaneous” performance of the battery as little as possible and, in some cases, in order to avoid any thermal runaway.

It is thus possible to manage the various stages of use of the battery coupled to a constant voltage charger without measuring current and while also avoiding thermal runaway.

The continuous low current preferably lies in the range about Ic/100 to Ic/5000, and more generally lies in the range Ic/500 to Ic/2000. In this case, the magnitude “Ic” designates the current Ic theoretically required for discharging the battery in one hour. For example, if Ic=40 amps (A), then it represents the current equivalent of a capacity C of 40 ampere hours (Ah).

In a first embodiment, the control means may be arranged in such a manner as to send the charging reference value to the charger when the charger is fitted with an input for this purpose. Under such circumstances, it is advantageous for the control means to be arranged in such a manner as to deliver the electrical reference values to the charger using any conceivable type of protocol, for example a protocol of the pulse-width modulation (PWM) type, or a “0-10 volt (V) reference signal” protocol, or a “4 milliamps (mA)-20 mA reference signal” protocol, or indeed by using a control area network (CAN) type bus.

In a second embodiment known as a “smart” battery, means are also provided to limit the current fed by the charger, which means are arranged to feed the battery as a function of the electrical reference value delivered by the control means.

In order to achieve standardization, it is possible for both embodiments to coexist on a single electronic card.

The measurement means preferably serve to deliver to the control means measurements of the local voltage at the terminals of at least one of the secondary electrochemical cells (and possibly all of them). It is also preferable for the measurement means to deliver to the control means measurements of local temperature in at least one of the secondary electrochemical cells of the battery.

In addition, the device may also include a communications interface coupled to the control means so as to exchange data with external computer equipment serving, for example, to modify the operation of the control means or to store operating data in order to retrace at least a fraction of events that have occurred in the battery.

The invention also provides a battery including a control device of the type described above.

Particularly advantageous applications of the invention lie in fields such as those of electrically-powered vehicles, aviation, rail transport, ground stations, handheld power tools, or telephony, in particular mobile telephony.

Other characteristics and advantages of the invention appear on examining the following detailed description and the accompanying drawings, in which:

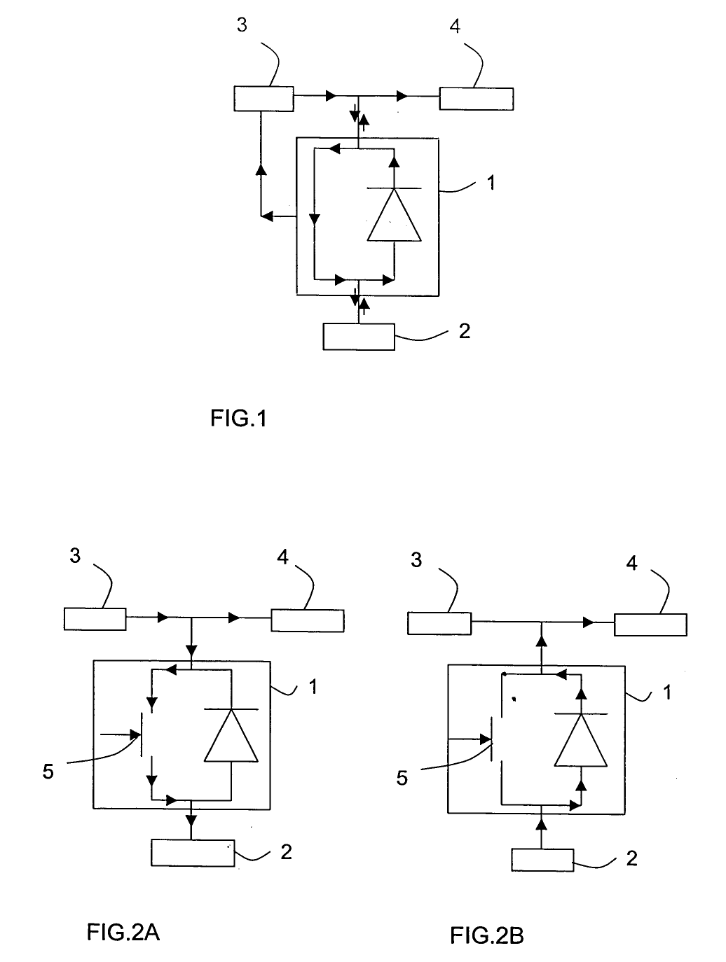

FIG. 1 is a block diagram showing coupling between a first embodiment of a control device of the invention, a battery, a charger, and electrical equipment;

FIGS. 2A and 2B are block diagrams showing coupling between a second embodiment of a control device of the invention, a second battery, a charger, and electrical equipment, respectively during the stage of charging the battery and powering the electrical equipment, and during the stage of discharging the battery via the electrical equipment;

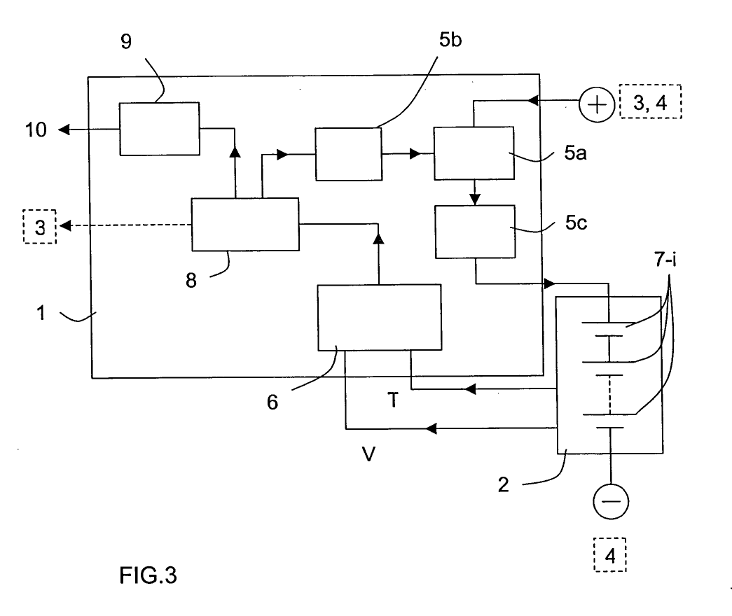

FIG. 3 is a block diagram of an embodiment of a control device of the invention corresponding to the block diagrams of FIGS. 2A and 2B; and

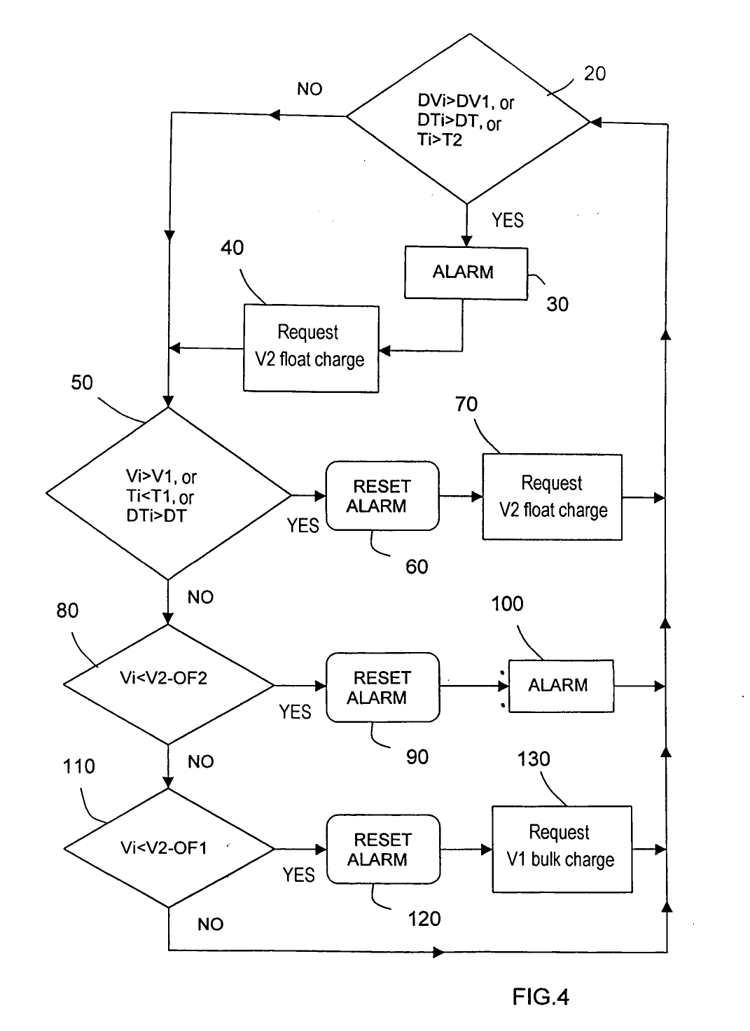

FIG. 4 is a flow chart for an algorithm showing one way in which the device of the invention can be operated.

The accompanying drawings may serve not only to complement to the description of the invention, but they may also contribute to defining it, where appropriate.

The invention is intended to monitor the state of charge of a battery constituted by one or more secondary (i.e. rechargeable) electrochemical cells. As an illustrative example, in the description below, it is assumed that the battery comprises n=3 secondary electrochemical cells connected in series, and constituted for example by nickel/metal-hydride (Ni/MH) or by nickel/cadmium (Ni/Cd) storage cells. It is also assumed that the battery is, by way of example, for installing in an uninterruptable power supply unit of a computer center for powering its main electrical equipment in the event of a failure in the mains electricity supply. Naturally, the invention is not limited to that application, and it may be used in other fields such as aviation, rail transport, ground stations, handheld power tools, and telephony.

In order to control state of charge, the invention proposes a device 1 for placing, as shown in FIGS. 1 and 2, in the interface between a battery 2, a constant voltage charger 3, and electrical equipment 4, also referred to as an application.

More precisely, in the embodiment shown in FIG. 1, the device 1 controls the state of charge in the battery 2 by giving the charger 3 a voltage value (U) that is appropriate for the battery at each instant. The way this action is implemented is described in greater detail below with reference to FIGS. 3 and 4.

When the battery 2 needs recharging, the device 1 determines the electrical reference value that will enable the charger 3 to feed the battery 2 with an appropriate constant voltage. When the battery 2 is charged and the application 4 itself needs powering (e.g. because of a failure in the power supply to the charger), said battery 2 powers said application 4. Finally, when the charger 3 comes back into operation, with the battery 2 then being insufficiently charged, the device 1 determines the electrical reference value for enabling the charger 3 to feed the battery 2 at an appropriate constant voltage while the charger 3 simultaneously powers the application with the electricity it needs. The appropriate voltage depends on the electrochemical couple involved.

In the embodiment shown in FIGS. 2A and 2B, the charger delivers a given direct current (DC) to the battery 2 at constant voltage, and the device 1 controls the state of charge of the battery 2 by acting on the mean value of the current fed to the battery 2 by chopping the current in a current-limiter module 5. This chopping may be implemented, for example, by an electronic component of the field-effect transistor (FET) type. This embodiment is known as a “smart” battery.

As shown in FIG. 2A, when the battery 2 needs to be recharged, the device 1 determines the electrical reference value that will enable the current limiter module 5 to feed the battery 2 at constant voltage with at least a fraction of the electricity delivered by the charger 3. As shown in FIG. 2B, when the battery 2 is charged and the application 4 needs to be powered (because the charger 3 has failed), said battery 2 feeds said application 4 via a power diode (for a very short length of time), and then via a switch connected in parallel and closed for this purpose. Finally, when the charger 3 becomes “present” again, but with the battery 2 then being insufficiently charged, said charger 3 powers the application 4 directly with the electricity it has available while, in parallel, also charging the standby battery. This state of affairs also corresponds to FIG. 2A.

Reference is now made to FIG. 3 to describe in detail an embodiment of the device 1 of the invention corresponding to the situation shown in FIGS. 2A and 2B (“smart” battery).

In this embodiment, the device 1 comprises firstly a measurement module 6 coupled to the battery 2 so as to measure, e.g. periodically, at least two physical magnitudes which characterize the battery, and in particular the voltage across the terminals of at least a portion of the battery and the temperature of at least a portion thereof. The measurement module 6 preferably delivers the local voltage across the terminals of at least one of the secondary electrochemical cells 7, and the local temperature of at least one of said secondary electrochemical cells 7.

In a less-sophisticated embodiment, the measurement module 6 might deliver only the total voltage across the terminals of the battery and the mean temperature of the entire battery 2.

The device 1 also comprises a control module 8 coupled to the measurement module 6 in such a manner as to control the state of charge of the battery 2 as a function of its own intrinsic characteristics and as a function of the measured voltage U and temperature T. It is this module which calculates the electrical reference values that enable the current fed to the battery 2 at each instant to be governed. The electrical reference values (current or voltage) are calculated as described below as a function of the voltage and temperature measurements as delivered by the measurement module 6. These reference values are proportional to the current (or voltage) needed for proper operation of the battery 2. Typically they lie in the range 0 to 1.5 volts (V) per cell (for a battery of alkaline cells).

The control module 8 is preferably implemented in the form of an application-specific integrated circuit (ASIC) or in the form of a programmed microcontroller (e.g. using the C language), depending on the type of battery 2 and possibly also the type of application 4 with which it is coupled. In this case it is coupled to a current limiter module 5 constituted by three portions in this example. A first portion 5a is coupled firstly to one of the outputs of the charger 3 (and one of the inputs of the application 4) physically embodied by the “+” terminal, and secondly to one of the terminals of the battery 2 (whose other terminal is physically embodied by the “−” terminal and is connected to the application 4). This is a module that is capable of being instructed to reduce the magnitude of the current delivered by the charger 3. A second portion 5b converts the electrical reference value instructions delivered by the control module 8 into instructions that enable the module 5a to determine the extent to which the current delivered by the charger 3 is to be reduced. An optional third portion 5c is interposed between the output of the module 5a and the input of the battery 2 in order to protect said battery 2.

Furthermore, in order to enable the control module 8 to be reprogrammed and/or to collect operating data, for optional storage in a memory (not shown) for the purpose of recapitulating at least a portion of the events to which the battery 2 has been subjected, the device 1 may include a communications interface 9, e.g. of the RS232 type, coupled to the control module 8 and suitable for being connected to computer equipment 10, for example a portable computer.

When the device 1 does not include a current limiter module 5 (or 5a-5c), and consequently corresponds to the embodiment shown in FIG. 1, the control module 8 has an output (represented by the dashed line arrow in FIG. 3) connected to the charger 2 so as to be able to supply it with data representative of the electrical reference values (when the charger is capable of interpreting such values). Under such circumstances, data exchange may be performed, for example, by using a pulse width modulation (PWM) type protocol, or by delivering an analog reference value of the 0-10 V type or of the 4 mA-20 mA type, or else by using CAN type bus. In such an embodiment, it is recalled that the charger 3 delivers at its output current that is variable as a function of the electrical reference values received from the control module 8, and that it does so under constant voltage, whereas in the embodiment that includes its own current limiter module 5, it is that module which acts (by chopping its own output current) to determine a current that varies as a function of the electrical reference values received from the control module 8 and as a function of the variable current (in the range 0 to I max) delivered by the charger 3 at constant voltage.

In addition, the control module 8 may be programmed in such a manner as to manage the state of health of the battery 2. In particular, it can detect failures, and possibly even predict failures, and it can also indicate its state of charge. This information can be stored for subsequent processing by an operator, after being extracted via the communications interface (e.g. of the RS232 type).

Reference is now made to FIG. 4 in order to describe an example of how the device 1 of the invention operates.

The control module 8 manages three main stages.

In a first stage, the battery 2 is lightly discharged. The total voltage V across its terminals is below a limit voltage V4. Consequently, the battery 2 needs to be recharged under rapid conditions by the charger 3 at constant voltage and at a current (I/BC=1/n) that is as high as can be delivered by the charger 3, with this continuing until a voltage electrical reference value as determined by the control module 8 is reached, such that the battery has returned the value V1 that corresponds to being practically fully charged. This rapid charging stage is known as “bulk” charging.

The end of bulk charging is characterized firstly by a temperature slope DTi greater than a threshold DT, and secondly by a voltage Vi across the terminals of at least a fraction i of the battery 2 (or of one of its secondary electrochemical cells 7-i) that is greater than V1, and thirdly by a temperature Ti of at least a portion i of the battery 2 (or of one of its secondary electrochemical cells 7-i) that is less than a theoretical temperature T1.

Consequently, the criteria for detecting the end of charging are, for example:

DT=KDT1+KDT2*I/BC;

if Ti<T3, V1=KV1+KT1*Ti+KC1*I/BC,

where T3 is a temperature threshold that varies as a function of the relationship governing the detection threshold, which relationship may be different at high temperature and at low temperature;

if Ti>T3, V1=KV2+KT2*Ti+KC2*I/BC; and

Ti<T1,

where T1 is a high limit temperature for proper operation of the battery, beyond which its lifetime will be degraded.

Furthermore, alarms are preferably issued when the following conditions arise (with the purpose of such alarms being to inform the user of operation that is abnormal, whether temporarily or permanently):

DVi>DV1; or

Ti>T2; or

δTi>DTC,

where δTi represents the temperature difference between two portions of a battery.

In a second stage, the battery 2 presents a total voltage across its terminals which is greater than the limit voltage V1. It is maintained in this state of charge either by causing the charger 3 to deliver a voltage V2 if it performs direct regulation, or else by chopping the current it delivers by means of the current limiter module 5 which controls the ON time of a relay so as to generate a mean current “Ic/n” lying in the range Ic/2000 to Ic/50 for an alkaline system, for example. This stage of charging is referred to as “float” charging insofar as it is performed by the charger 3 under continuous charging conditions ( “floating” charging). The value given to this current Ic/n depends on the electrochemical couple involved.

The theoretical voltage V2 can be defined by the relationship V2=KV3+KT3*Ti.

The end of floating charging is not characterized given that it is terminated by a subsequent discharge. However, it is preferable to issue an alarm in the event of the following conditions arising:

DVi>DV1 in the event of dispersion between the states of charge within the battery;

Ti>T2 in the event of any tendency to thermal runaway; or

δTi>DTC in the event of the battery not performing uniformly.

In a third stage, the battery 2 is deeply discharged as can happen if the charger 3 has failed for a long period of time. This stage corresponds to a “discharged” state associated with a limit voltage V3.

It is preferable to issue an alarm when the following conditions arise:

DVi>DV1; or

Vi>V3 (V3 can be defined from V2 which is close to the open circuit voltage for state of charge of about 100%; for example V3=V2-OF2); or

Ti>T2.

Furthermore, a return to the bulk charging stage in order to return to full charge can be triggered by the condition Vi<V4, where V4 can also be defined from V2; for example V4=V2-OF1 This makes it possible to avoid recharging batteries at high current when they are hardly discharged at all, and thus avoid heating them when there is no need to return quickly to a high state of charge.

It is important to observe that the above-mentioned variable values depend on the electrochemical couple involved.

An algorithm for managing the three above-described stages can begin with a first test (step 20 of FIG. 4). In this step 20, the control module determines DVi and DTi on the basis of measurements delivered by the measurement module 6. In addition, it compares firstly DVi with the threshold DV1, secondly DTi with the threshold DT, and thirdly Ti with T2 in order to verify the state of “health” of the battery.

If the result of the test at step 20 indicates that DVi is greater than DV1, or that DTi is greater than DT, or indeed that Ti is greater than T2, that means that there is an anomaly and that it is preferable to place the battery 2 in its floating charge state in order to attempt to make the anomaly disappear (while indicating that it has occurred and possibly also storing it). In a step 30, the control module 8 then generates an alarm which it preferably stores in one of its memories, so that the content of the alarm can be analyzed a posteriori, making it possible to verify whether the problem that has arisen is one-off or is recurring. Thereafter, in a step 40, floating charging is started at voltage V2. The control module 8 then moves onto a step 50.

If the result of the test at step 20 indicates that DVi is less than DV1, that DTi is less than DT, and that Ti is less than T2, then the algorithm passes on directly to step 50.

Step 50 serves to verify whether the conditions indicating the end of bulk charging are satisfied. It consists in performing three tests on the voltage Vi and temperature Ti values of the secondary electrochemical cell 7-i. If the result of the test at step 50 indicates that Vi is greater than V1 or that Ti is less than T1, or indeed that DTi is greater than DT, that means that the battery 2 is in an overcharged (or abused) state, i.e. it has gone beyond the state of bulk charging. The control module 8 then resets the alarm to its initial state (step 60), and then triggers a stage of floating charging at voltage V2 (step 70) in order to maintain the maximum charge state that has been reached. This returns to step 20.

In contrast, if the result of the test at step 50 indicates that Vi is less than V1, that Ti is greater than T1 or that DTi is less than DT, then the algorithm passes onto step 80.

Step 80 is intended to verify whether the end of discharging can be reached. It consists in performing a test on the value of the voltage Vi of at least one of its portions in order to determine whether the battery 2 is 100% discharged. If the result of this test indicates that Vi is below a theoretical voltage V3, that means that the battery 2 has discharged below the authorized limit. The control module 8 resets the alarm (step 90), and then generates an alarm (step 100) which it preferably stores in one of its memories. Thereafter, depending on the application, either it leaves the battery 2 connected in spite of the risk of destroying it, or else it is decided to open the circuit. Thereafter, the algorithm returns to step 20.

In contrast, if the result of the test of step 80 indicates that Vi is greater than V3, that means that it might be necessary to recharge the battery 2. In order to determine whether this is the case, the algorithm moves onto step 110.

This step 110 consists in performing a new test on the value of the voltage Vi of the secondary electrochemical cell 7-i. If the result of this test indicates that Vi is greater than the theoretical voltage V3, but less than a theoretical voltage V4, that means that the battery 2 has been discharged sufficiently to allow it to be recharged in bulk charging mode. The control module 8 resets the alarm (step 120) and then requests a stage of bulk charging under voltage V1(step 130), thereby returning to step 20. The value of OF1 must then be great enough to allow bulk charging mode to be restarted for depths of discharge greater than 5%. In addition, the value of OF2 must be high enough to be sure of detecting the end of discharging.

In contrast, if the result of the test in step 110 indicates that Vi is greater than V3 and V4, that means that the algorithm remains in bulk charging mode. Since the situation is “normal”, the algorithm returns to step 20.

The above-described algorithm (or method) relies on making comparisons between thresholds (or limits) and “local” measurements performed on a portion i of the battery 2. However, the algorithm could be applied in succession to a plurality of portions of the battery 2, or even to each of its secondary electrochemical cells 7-i. Similarly, the algorithm may be applied to the entire battery 2. Under such circumstances, it is necessary to measure the voltage across the terminals of the battery 2 and the mean temperature of the battery.

Furthermore, a control device is described above that is separate from the battery and that is connected thereto. However the control device may be directly integrated in the battery unit.

In addition, the control device may be arranged in the form of an electronics card, e.g. in the form of a sheet suitable for integrating in the battery connections.

The invention is not limited to the embodiments of the control device and the battery described above, purely by way of example, but covers any variant that might be envisaged by the person skilled in the art within the ambit of the following claims.

1. A device for controlling charging (1) of a battery (2) comprising one or more secondary electrochemical cells (7), the device being interfaced between a battery charger (3), the battery, and at least one piece of electrical equipment (4), the device being characterized in that it comprises: i) measurement means (6) arranged to deliver measurements of a first physical magnitude representative of at least one voltage (U) across the terminals of at least a portion of said battery (2), and of a second physical magnitude representative of at least one temperature (T) of at least a portion of said battery (2); and ii) control means (8) arranged to determine, as a function of the measurements of said first and second magnitudes, an electrical control value enabling the battery (2) to be maintained in a selected state of charge and at a mean temperature that is significantly below a selected threshold by using a continuous low current at constant voltage, and without measuring said current.

2. A device according to claim 1, characterized in that said control means (8) are arranged to deliver said charging reference value to said charger (3).

3. A device according to claim 1, characterized in that said control means are arranged in such a manner as to deliver the electrical reference value to said charger using a protocol selected from the “PWM” protocol, the “0-10 V” protocol, and the “4 mA-20 mA” protocol.

4. A device according to claim 1, characterized in that it includes current limiter means (5) fed with current by said charger (3) and arranged in such a manner as to feed said battery (2) as a function of said electrical reference value as delivered by said control means (8).

5. A device according to claim 1, characterized in that said electrical reference value is representative of a current.

6. A device according to claim 1, characterized in that said electrical reference value is representative of a voltage.

7. A device according to claim 1, characterized in that said measurement means (6) are arranged to deliver to said control means (8) measurements of the local voltage across the terminals of at least one of the secondary electrochemical cells (7) of said battery.

8. A device according to claim 7, characterized in that said measurement means (6) are arranged to deliver to said control means (8) measurements of the local voltage across the terminals of each secondary electrochemical cell (7) of said battery (2).

9. A device according to claim 1, characterized in that said measurement means (6) are arranged to deliver to said control means (8) measurements of the local temperature of at least one of the secondary electrochemical cells (7) of said battery (2).

10. A device according to claim 1, characterized in that said low charging current lies in the range about Ic/100 to Ic/5000, and in particular in the range Ic/500 to Ic/2000.

11. A device according to claim 1, characterized in that it includes a communications interface (9) coupled to said control means (8).

12. A battery (2) comprising at least one secondary electrochemical cell (7), the battery being characterized in that it is fitted with a control device (1) according to any preceding claim claim 1.

13. A battery (2) according to claim 12, characterized in that said secondary electrochemical cells (7) are selected from a group comprising at least: nickel/metal-hydride (Ni/MH), nickel/cadmium (Ni/Cd), lithium/ion (Li/Ion), and lead-acid (Pb/PbO2) storage cells.

14. A device (1) for controlling a battery (2) according to claim 1, the device being used in a field selected from the group comprising: electrically-powered vehicles, aviation, rail transport, ground stations, handheld power tools, and telephony.
